(19) United States
(12) Patent Application Publication
(10) Pub. No.: US 2003/0200002 A1
(43) Pub. Date: Oct. 23, 2003

(54) Portable CD-MP3 system and file decoding method of operating the same

(75) Inventor: Kang-Duek Kwon, Kwacheon-City (KR)

Correspondence Address: Anthony P. Onello, Jr., MILLS & ONELLO LLP, Eleven Beacon Street, Suite 605, Boston, MA, 02108, US

(73) Assignee: Samsung Electronics Co., Ltd.

(21) Appl. No.: 10/369,002

(22) Filed: Feb. 19, 2003

(30) Foreign Application Priority Data
Apr. 19, 2002 (KR) 02-21678

(51) Int. Cl. G06F 17/00; G06F 15/16

(52) U.S. Cl. 700/94; 709/217

(57) ABSTRACT

A portable CD-MP3 system and a file system decoding method of operating the same utilize a high-performance DSP to decode an audio file in analyzing a file system. The DSP stores data regarding the file system information in a right-channel region of a memory unit if the analyzed file system information represents the title of an audio file, and stores the data in a left-channel region of the memory unit for navigation of the audio file if the analyzed file system information does not represent the title of the audio file.

### BACKGROUND OF THE INVENTION

1. Field of the Invention

The present invention relates to an audio decoding system, and more particularly, to a portable CD-MP3 system and a file decoding method of operating the same.

2. Description of the Related Art

Computers and household electric appliances are continually under development, with the goal to increase user convenience. As a part of this trend, the MP3 data file format, which represents MPEG-1 Audio Layer 3, has been developed, through which high-quality music in digital format can be enjoyed, at the same level of quality as music recorded on a compact disc (CD). Early in development, a computer was required for the playback of MP3-formatted music, which was somewhat inconvenient. This triggered the development of portable MP3 players that are able to execute an MP3 file without the need for a computer. Originally, MP3 players had only fundamental music playback functions. As development continues, MP3 players include an ever-increasing amount of functionality.

There are two conventional ways in which MP3 files can be played through a portable appliance: (i) MP3 files can be executed by an MP3 player; and (ii) an MP3 file is converted into a wave file format (.wav), recorded on a CD, and then reproduced by a CD player. However, the first approach, i.e., using the MP3 player, is disadvantageous in that the use of flash memory for storing MP3 files is relatively expensive and places a limitation in the amount of music that can be stored. The second approach, i.e., using the CD player, is also disadvantageous in that the size of an MP3 file stored on the CD generally increases upon conversion of the MP3 file into a wave file, thereby making it impossible to store a large number of MP3 files on a CD media, even though CD-ROMs have a large storage capacity of 650 MB.

To solve these problems, a portable CD-MP3 player that is capable of both playing CD-ROMs and executing MP3 files has been developed. The CD-MP3 player can execute MP3-formatted files stored on a CD as well as general standard audio files in wave format, without the need for converting the wave file format to an MP3 file format.

FIG. 1 is a block diagram of the structure of a general portable CD-MP3 system 100. Referring to FIG. 1, the portable CD-MP3 system 100 includes a CD driving unit 120, an audio reproduction unit 130, a system controller 140, and a memory unit 150.

The CD driving unit 120 includes a radio-frequency (RF) & servo controller 122 and a motor driver 124 and is responsible for controlling the driving of, and reading of information from, a CD 110. The audio reproduction unit 130 includes a CD decoding unit 132 and an MP3 decoding unit 134 and decodes audio files stored in the CD 110. The CD decoding unit 132 decodes uncompressed standard audio files, such as wave files, stored on the CD 110, and the MP3 decoding unit 134, for example in the form of a digital signal processor (DSP), decodes compressed audio files such as MP3 files stored on the CD or stored in memory.

The system controller 140, for example in the form of a microcomputer, analyzes the file system of audio files stored in the CD 110 and selects a desired audio file according to the analysis result while controlling the operation of the CD driving unit 120 and the audio reproduction unit 130.

The memory unit 150 includes dynamic random access memory (DRAM) or flash memory and stores data that is analyzed by the system controller 140.

In general, a portable CD-MP3 player optimizes the functions of a DSP chip to unpack compressed audio files stored in the CD 110. Therefore, the microcomputer external to the DSP chip, i.e., the system controller 140, analyzes the file system of the audio file, e.g., the position, name, and tag information, classifies the analysis result and stores the result in the memory unit 150.

However, a large amount of time is consumed in analyzing the file systems of MP3 files, which contain a large amount of data, with a general microcomputer, and further, the use of a high-quality microcomputer increases manufacturing costs for a CD-MP3 player.

### SUMMARY OF THE INVENTION

To address the above limitations, it is a first object of the present invention to provide a CD-MP3 system that is capable of minimizing the amount of time consumed in analyzing CD-MP3 file system data with minimal use of a microcomputer, and a file system decoding method therefor.

It is a second object of the present invention to provide a CD-MP3 system that effectively classifies and stores CD-MP3 file system data in a memory unit thus reducing waste of a data storage space of a memory unit and data access time, and a file system decoding method therefor.

To achieve the first object, there is provided a portable CD-MP3 system including an audio reproduction unit for decoding an audio file and analyzing a file system of the audio file; a memory unit for storing information on the decoded audio file and the analyzed file system; and a system controller for selecting an audio file based on the analyzed file system information and controlling the decoding operation of the audio reproduction unit to reproduce the selected audio file.

To achieve the second object, there is provided a file system decoding method for operating a portable CD-MP3 system, the file system decoding method including (a) receiving MSF information of a CD frame and analyzing file system information based on the MSF data; (b) storing data regarding the analyzed file system information in an R-CH region of a memory unit if the analyzed file system information represents the title of an audio file; and (c) storing data regarding the analyzed file system information in an L-CH region of the memory unit for navigation of the audio file if the analyzed file system data does not represent the title of an audio file.

Preferably, (c) includes (c-1) storing the overall information regarding the file system in a first region of the L-CH region; (c-2) storing data regarding directory-level navigation information in a second region of the L-CH region; and (c-3) storing data regarding file-level navigation information of the file system in a third region of the L-CH region.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram of the structure of a general portable CD-MP3 system;

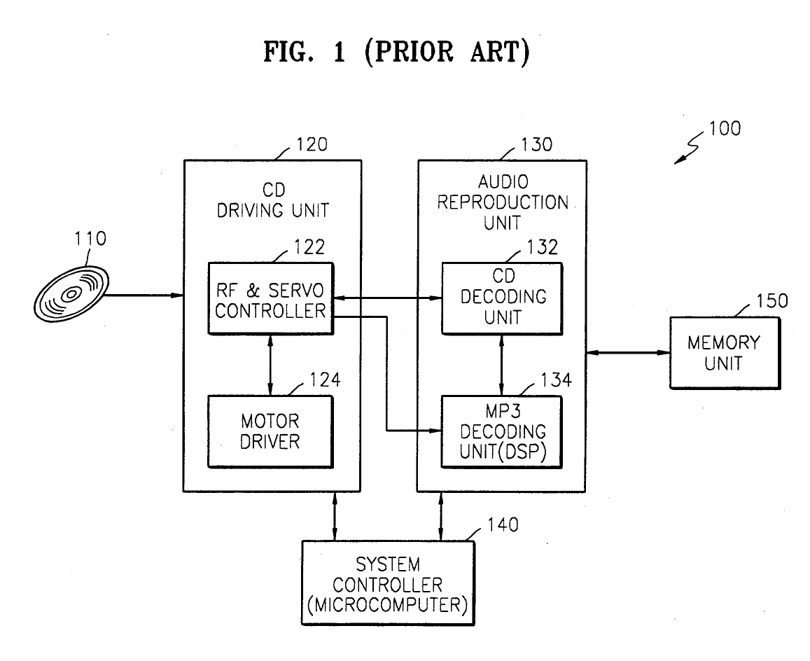

FIG. 2 is a block diagram of a preferred embodiment of a portable CD-MP3 system according to the present invention;

FIG. 3 is an example memory map of the memory unit shown in FIG. 2;

FIG. 4 is an example memory map showing file system data each stored in a left channel region, i.e., a first output buffer, and a right channel region, i.e., a second output buffer, of the memory unit shown in FIG. 3; and

FIG. 5 is a flow chart explaining a preferred embodiment of a file system analysis method according to the present invention.

### DETAILED DESCRIPTION OF PREFERRED EMBODIMENTS

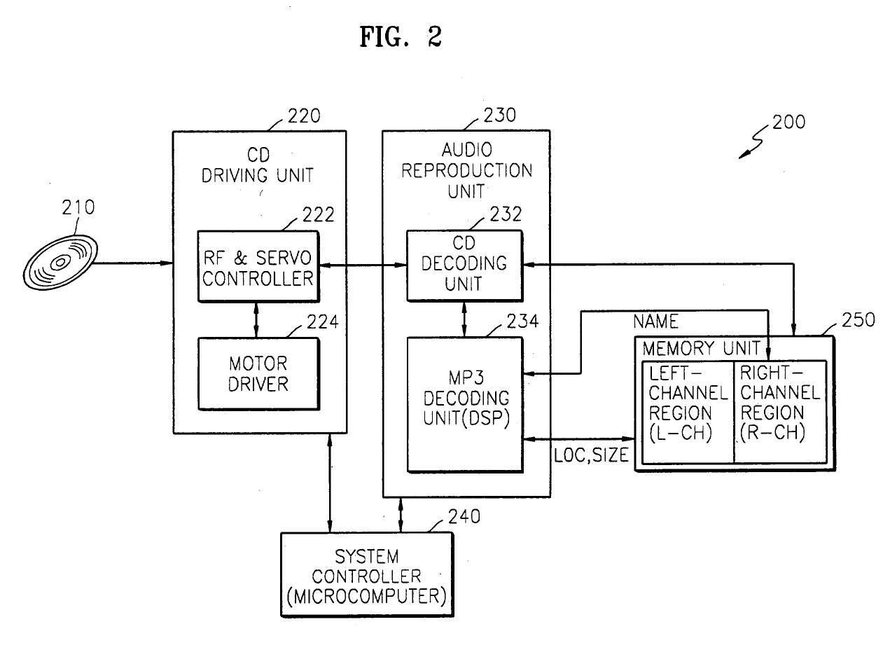

FIG. 2 is a block diagram of a preferred embodiment of a portable CD-MP3 system 200 according to the present invention. Referring to FIG. 2, the portable CD-MP3 system 200 includes a CD driving unit 220, an audio reproduction unit 230, a system controller 240, and a memory unit 250. The CD driving unit 220 includes a radio-frequency (RF) & servo controller 222 and a motor driver 224, and the audio reproduction unit 230 includes a CD decoding unit 232 and an MP3 decoding unit 234.

The CD driving unit 220 drives a CD 210 with the RF & servo controller 222 and the motor drive 224 under control of the system controller 240. The CD decoding unit 232 decodes uncompressed audio files, i.e. wave files, under the control of the system controller 240, and the MP3 decoding unit 234 decodes compressed audio files, i.e., MP3 files, under the control of the system controller 240. For the decoding of compressed audio files, the MP3 decoding unit 234 functions as a digital signal processor (DSP) having the function of decoding MP3 files. In addition, the MP3 decoding unit 234 analyzes the file system of compressed audio files stored in the CD 210 and creates a database of the result of the analysis.

The MP3 decoding unit 234 is in the form of a digital signal processor (DSP) in this embodiment, however, the entire audio reproduction unit 230 may also be in the form of a DSP including the dual function of both the CD decoding unit 232 and the MP3 decoding unit 234. Further, compressed audio files processed by the MP3 decoding unit 234 may be in the form of other formats, such as the window media audio (WMA) format or transform-domain weighted interleave vector quantization format (VQF), as well as the MP3 format.

The memory unit 250 includes dynamic random access memory (DRAM), or flash memory, and is used to store audio files decoded by the audio reproduction unit 230 and file system data analyzed by the audio reproduction unit 230.

The system controller 240, for example in the form of a microcomputer, selects a desired audio file based on the analysis result of the file system stored in the memory unit 250, and controls the operations of the CD driving unit 220 and the audio reproduction unit 230 so as to play back a segment of music contained in the selected audio file.

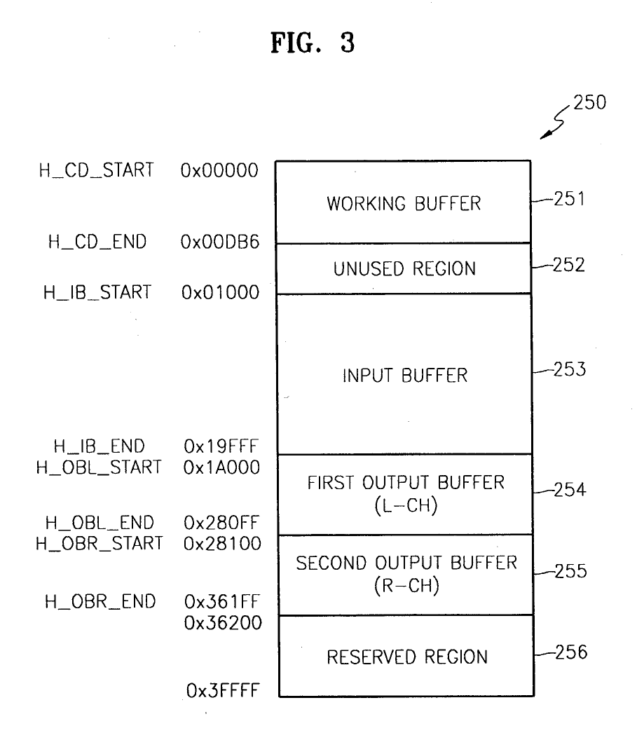

FIG. 3 is a memory map of the memory unit 250 shown in FIG. 2, providing an example as to the manner in which the decoded audio files and the file system data are stored for play back and analysis by the MP3 decoding unit 234. Referring to FIG. 3, the memory unit 250 includes a working buffer 251, an unused region 252, an input buffer 253, first and second output buffers 254 and 255, and a reserved region 256.

The memory unit 250 utilizes the working buffer 251 to store data to be processed and utilizes the first output buffer 254 and the second output buffer 255 as a left-channel (L-CH) buffer and a right-channel (R-CH) buffer, respectively. The first output buffer 254 stores L-CH data of an audio file as decoded by the CD decoding unit 232 or the MP3 decoding unit 234, and the second output buffer 255 stores R-CH data of the audio file. This enables an electrical shockproof (ESP) function through which music contained in the audio file can be played back without being interrupted, irrespective of external shock applied to the console of the system. In addition, the first and second output buffers 254 and 255, store data from the CD-ROM file system (CDFS) information, for example in ISO9660 format, Joliet format, or Romeo format. The data is created according to its format features and stored, so that the stored data does not overlap with decoded music data.

Analysis and storage of file system data are performed by the DSP, i.e., the MP3 decoding unit 234. In general, a data channel of about 20 K bytes in size is formed in the DSP to process compressed audio data such as MP3 data. The data channel in the DSP is assigned to the memory unit 250 as shown in the memory map of FIG. 3. Despite its excellent data processing capability, the DSP is employed by current CD-MP3 systems only when decoding compressed audio files, such as MP3 files, and not when analyzing the file system data of the CD 210. Instead, the file system data of the CD 210 is analyzed by the external microcomputer 240, which places a drain on the resources of the microcomputer 240, and increases the need for a microcomputer 240 of enhanced complexity and speed, and therefore expense.

However, the CD-MP3 system 200 according to the present invention utilizes the high-performance data processing capabilities of the DSP 234 of the audio reproduction unit 230 so as to analyze the file system data of the CD 210, classifies the analyzed file system appropriately, and stores it in the memory unit 250 according to the memory map of FIG. 3. Since, in the present invention, the DSP 234 of the audio reproduction unit 230 is responsible for analyzing the file system data, rather than the external microcomputer 240, the specifications of the external microcomputer, i.e., the system controller 240, can be alleviated, such that the system controller 240 carries out merely fundamental data processing and control of the CD driving unit 220.

The MP3 decoding unit 234, for example in the form of a DSP, analyzes file system data and delivers location information with respect to a desired compressed audio data located on a CD in minute/second/frame (MSF) format to the system controller 240. The system controller 240 transfers the corresponding compressed audio data to the memory unit 250 in response to the MSF information.

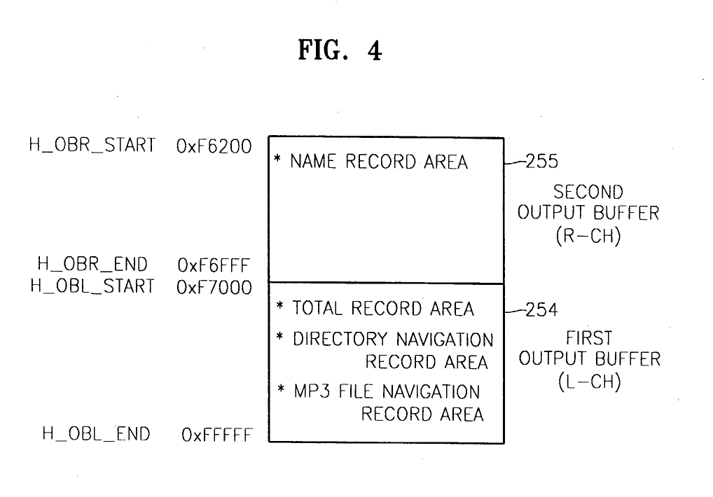

FIG. 4 is a view of a memory map showing example file system data stored in a left channel (L-CH) region, i.e., the first output buffer 254, and a right channel (R-CH) region, i.e., the second output buffer 255, of the memory unit 250. The L-CH and R-CH regions of the memory unit 250 are used in the system and process of the present invention, not only in storing music data as previously mentioned, but also during the analysis of the CD-ROM file system data by the DSP of the audio reproduction unit 130.

In general, file system data related to an MP3 file, e.g., the position, size and type of data has a regular, predictable length, whereas the data length of the title of an MP3 file varies over a range from one character to several dozens of characters. In the conventional embodiment, if the number of MP3 files is increased, it is not completely stored in the working buffer 251 when counting the quantity of MP3 files.

To solve this problem, the MP3 decoding unit 234 according to the present invention, in the form of the DSP, stores all titles of MP3 files in the R-CH region of the memory map, i.e., the second output buffer 255. In addition, the MP3 decoding unit 234 temporarily stores MP3 file system data (e.g., the position, size, and type of data, as well as data indicating the directories of MP3 files, the number of files listed in each directory, and the names of the directories) in the working buffer 251 and then classifies and stores them in the L-CH region (first output buffer 254) of the memory map. In this manner, it is possible in the system and process of the present invention to minimize waste of the data storage space of the memory unit 250 and further minimize data access time. This is because in the present invention, the DSP stores the title of an audio file of the file system information in the right-channel (R-CH) region and stores all file system information except the title of the audio file in the left-channel (L-CH) region. If the file system information were otherwise stored in series in the R-CH region or L-CH region without classification, pointers indicating the next start positions of the audio files are required. Thus, data storage space for storing the pointers in the R-CH region and/or L-CH region would also be required, and time for analyzing the pointers in the system controller 240 would also be required.

Referring to FIG. 4, the file system analyzed by the MP3 decoding unit 234 is divided into four tables and stored in the memory unit 250. Among the four tables, the first one is a name record area that contains the titles of compressed audio files and is stored in the second output buffer 255, which is the R-CH region of the memory unit 250.

The other three tables comprise a total record area, a directory navigation record area, and an MP3 file navigation record area, respectively, that contain information regarding the compressed audio files (e.g., their positions, sizes, and kinds) and are stored in the first output buffer 254 which is the L-CH region of the memory unit 250. The organization of these tables is illustrated in the following three tables, where “number” refers to the number of tracks on a CD.

TABLE 1
Total Record Area

| | Record | |
|---|---|---|
| | (2 bytes record and | |
| Address | hexadecimal) | Description |
| 0 | Total directory number | TotalDirNum |
| 1 | Total MP3 file number | |
| 2 | MP3 directory number | Directory |
| 3 | MP3 start directory number | counter start |
| | | from 1 |

TABLE 2
Directory Navigation Record Area

| | Record | |
|---|---|---|
| | (2 bytes record and | |
| Address | hexadecimal) | Description |
| 4 | Start MP3 file number | |
| 5 | MP3 file number in directory | |
| 6 | Directory identifier length | |
| 7 | Parent directory number | |
| 8 | Sub directory number | |
| 9 | Next directory number | |

A-F, 10-15, 16-1B . . . (loop for total directory number)

TABLE 3
MP3 File Navigation Record Area

| | Record | |
|---|---|---|
| Address | (2 bytes record and hexadecimal) | Description |
| X | MP3 file min., second information | MS |
| X + 1 | MP3 file frame information | OF (F is lower |
| | | 8 bits |
| X + 2 | MP3 file data length high | Length is |
| X + 3 | MP3 file data length low | total 4 bytes |
| X + 4 | MP3 file identifier length | |
| X + 5 | MP3 file type | |

Loop for total MP3 file number, X = 4 + TotalDirNum*6
MSF record is decimal value

In Table 1, the total record area of memory stores information regarding the overall MP3 file system such as total number of directories, the number of MP3 files, and the starting directory number. In Table 2, the directory navigation record area of memory stores information regarding directory-level navigation such as the starting ML3 file number, MP3 file numbers listed in directories, the length of the directory identifier, the parent directory number, sub directory numbers, and the next directory number. The MP3 file navigation record area of Table 3 stores information related to file-level navigation such as the running time of the MP3 file (indicated in minute and second units), MP3 file frame information, the length of MP3 file data, the length of the MP3 file identifier, and the type of MP3 file.

After the file system data, including the directories and information related to the MP3 files stored on the CD 210, is stored in the memory unit 250, the system controller 240 can obtain the information on a desired MP3 file irrespective of the overall length of the MP3 file by changing its pointer position. For this example, the pointer position can be advanced by 6 bytes, since Table 3 contains a data header for each MP3 file that is repeated every 6 bytes. For this reason, it is relatively easy and convenient to obtain the information on a desired MP3 file. Further, Table 2 in memory stores the sub-directory number and the next directory number, including the parent directory information, thus enabling easy navigation. These sub-directory number data and next-directory number data are stored in the memory unit 250 as shown.

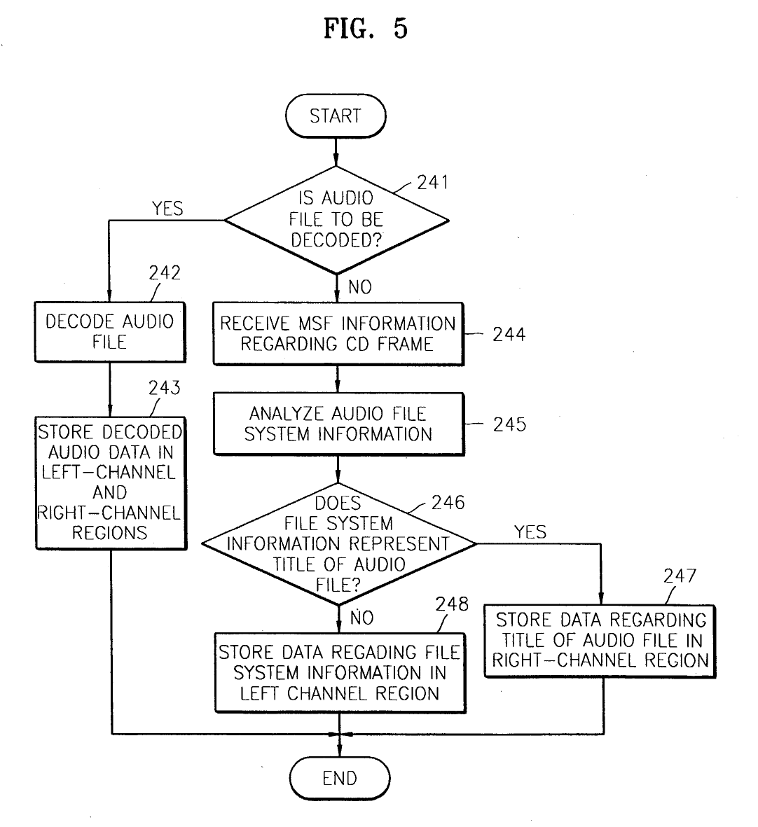

FIG. 5 is a flow diagram that provides the process steps of a preferred embodiment of a file system analysis method according to the present invention. Referring to FIG. 5, the CD-MP3 system 200 determines whether an audio file is to be decoded or not, in step 241.

If it is determined in step 241 that the CD-MP3 system 200 is to decode the audio file, the audio reproduction system 230, which is one element of the CD-MP3 system 200, decodes the audio file in step 242 and then stores the decoded audio file in the L-CH and R-CH regions of the memory unit 250 in step 243.

However, if it is not determined in step 241 that the CD-MP3 system 200 is to decode the audio file, the MP3 decoding unit 234, which is also an element of the CD-MP3 system 200, receives MSF information regarding the CD frame in step 244. Thereafter, the MP3 decoding unit 234 analyzes the audio file system based on the MSF information in step 245, and then determines whether the file system information represents the title of the audio file in step 246.

If it is determined in step 246 that the file system information represents the title of an audio file, the MP3 decoding unit 234 creates data regarding the title of the audio file and stores the data in the R-CH region of the memory unit 250 in step 247. Otherwise, if the received MSF data is not related to the title of an audio file, that is, it represents the position, size and kind of the audio file, the MP3 decoding unit 234 stores the MSF data in the L-CH region of the memory unit 250, in step 248.

Such a file system analysis method requires a small quantity of a storage space in the memory unit 250, rather than an additional system. The file system analysis method shown in FIG. 5 is advantageous in that the titles and other information of audio files are stored in the R-CH region and the L-CH region, respectively, and thus, waste of data storage space and data access time are reduced, as compared to conventional file system analysis methods. Further, unlike the existing CD-MP3 systems, the CD-MP3 system according to the present invention employs the utility of the DSP used for decoding the MP3 files, rather than utilizing a large-capacity external microcomputer, when analyzing the file system, thereby minimizing the processing specifications of the microcomputer.

While this invention has been particularly shown and described with reference to preferred embodiments thereof, it will be understood by those skilled in the art that various changes in form and details may be made herein without departing from the spirit and scope of the invention as defined by the appended claims.

As described above, a portable CD-MP3 system and a file system decoding method of operating the same according to the present invention can analyze and store a file system, using a high-performance DSP thus minimizing time spend on analyzing data regarding a CD-MP3 system, and can reduce the amount of data exchanged between a microcomputer and the DSP thus reducing power consumption.

In addition, according to the present invention, the microcomputer is configured to perform minimal operations so that its required specifications can be minimized, and further, file system data is effectively classified and individually stored in two regions of a memory unit, thereby reducing waste of a data storage space of the memory unit and data access time.

What is claimed is:

1. A portable CD-MP3 system comprising:
an audio reproduction unit for decoding an audio file and analyzing file system data of the audio file;
a memory unit for storing information related to the decoded audio file and the analyzed file system data; and
a system controller for selecting an audio file based on the stored information and for controlling the decoding of the audio file by the audio reproduction unit, to reproduce the selected audio file.

2. The portable CD-MP3 system of claim 1, wherein the audio reproduction unit comprises:
a first audio decoding unit for decoding an uncompressed audio file; and
a second audio decoding unit for decoding a compressed audio file.

3. The portable CD-MP3 system of claim 1, wherein the memory unit comprises:
a first output buffer for storing left-channel (L-CH) data regarding the decoded audio file; and
a second output buffer for storing right-channel (R-CH) data regarding the decoded audio file,
wherein a portion of the second output buffer stores data related to a title of the compressed audio derived from the analyzed file system data, and a portion of the first output buffer stores navigation data derived from the analyzed file system data.

4. The portable CD-MP3 system of claim 3, wherein the first output buffer comprises:
a first portion storing overall data related to the analyzed file system data;
a second portion storing directory-level navigation data related to the analyzed file system data; and
a third portion storing file-level navigation data related to the analyzed file system data.

5. The portable CD-MP3 system of claim 4, wherein the first portion stores overall data regarding the number of directories, the number of files, the directory name and the starting directory name of the selected audio file.

6. The portable CD-MP3 system of claim 4, wherein the second portion stores data regarding a starting number of the selected audio file, number in a directory, the length of directory identifier, the parent directory, a sub directory, and the next directory.

7. The portable CD-MP3 system of claim 4, wherein the third portion stores data regarding the running time, frame information, length of data, length of an identifier and kind of the selected audio file.

8. The portable CD-MP3 system of claim 1, wherein the file system is one of ISO9660 format, Joliet format, and Romeo format.

9. The portable CD-MP3 system of claim 2, wherein the compressed audio file has a MP3 format, a WMA format, or a VQF format.

10. The portable CD-MP3 system of claim 1, wherein the audio reproduction unit comprises a digital signal processor (DSP) chip having the audio file decoding function.

11. The portable CD-MP3 system of claim 1, wherein the memory unit comprises dynamic random memory (DRAM) or flash memory.

12. A file system decoding method for operating a portable CD-MP3 system, the file system decoding method comprising:
(a) receiving MSF information of a CD frame and analyzing file system information based on the MSF data;
(b) storing data regarding the analyzed file system information in an R-CH region of a memory unit if the analyzed file system information represents the title of an audio file; and
(c) storing data regarding the analyzed file system information in an L-CH region of the memory unit for navigation of the audio file if the analyzed file system information does not represent the title of an audio file.

13. The file system decoding method of claim 12, wherein step (c) comprises:
(c-1) storing the overall information regarding the file system in a first region of the L-CH region;
(c-2) storing data regarding directory-level navigation information in a second region of the L-CH region; and
(c-3) storing data regarding file-level navigation information of the file system in a third region of the L-CH region.

14. The file system decoding method of claim 13, wherein the first region holds data regarding the whole directory numbers, whole file numbers, directory number and starting directory number of the compressed audio file.

15. The file system decoding method of claim 13, wherein the second region holds data regarding a starting file number of the compressed audio file, the compressed audio file number in a directory, the length of a directory identifier, a parent directory number, a sub directory number, and the next directory number.

16. The file system decoding method of claim 13, wherein the third region holds data regarding the running time, frame information, data length, identifier length and kind of the compressed audio file.
